(19) United States
(12) Patent Application Publication
(10) Pub. No.: US 2026/0274440 A1
(43) Pub. Date: Sep. 17, 2026

(54) DEVICE FOR ATTACHING A HEAT SHIELD TO AN AIRCRAFT PANEL AND ASSOCIATED METHOD

(71) Applicant: SAFRAN NACELLES, Gonfreville-L'Orcher (FR)

(72) Inventors: Yanhaël Labat, Moissy-Cramayel (FR); Laurent Ruban, Moissy-Cramayel (FR); Philippe Leroux, Moissy-Cramayel (FR); Arnaud Cammage, Moissy-Cramayel (FR); Tony Miossec, Moissy-Cramayel (FR); Charles-Antoine Lampaert, Moissy-Cramayel (FR); Jean-Philippe Joret, Moissy-Cramayel (FR); Alexis Yves-Marie Loncle, Moissy-Cramayel (FR); Mathieu David, Moissy-Cramayel (FR)

(73) Assignee: SAFRAN NACELLES, Gonfreville-L'Orcher (FR)

(21) Appl. No.: 19/479,940

(22) PCT Filed: May 2, 2024
(86) PCT No.: PCT/FR2024/050567

§ 371 Date: Oct. 29, 2025

(30) Foreign Application Priority Data
May 12, 2023 (FR) FR2304731

(51) Int. Cl. B64F 5/10; B64D 27/10; B64D 29/00; F02C 7/24

(52) U.S. Cl. CPC B64F 5/10; B64D 27/10; B64D 29/00; F02C 7/24

(57) ABSTRACT

This device for attaching a heat shield to an aircraft panel comprises a first attachment element associated with the heat shield, a second attachment element associated with the aircraft panel, and a metal wire forming a loop. At least one of said attachment elements is provided with means for retaining said loop, said loop being closed by a braking member at the ends of said loop, intended for bringing said attachment elements together; the loop abutting respectively in the middle portion one of the attachment elements and at the braking member on the other attachment element. The loop is set apart from the heat shield and from the aircraft panel, and passes outside the heat shield and the aircraft panel.

### TECHNICAL FIELD

The present invention relates to a device for attaching a heat shield to an aircraft panel.

### Prior Art

An aircraft is driven by one or more turbojet engines each housed in a nacelle. A nacelle generally has a substantially tubular structure comprising an air inlet upstream of the turbojet engine, an intermediate assembly intended to surround a fan of the turbojet engine and a rear assembly that may integrate thrust reversal means and intended to surround the combustion chamber and all or part of the compressor and turbine stages of the turbojet engine. Moreover, the nacelle includes an ejection nozzle, the outlet of which is located downstream of the turbojet engine.

In a turbojet engine, some areas may be likely to catching fire in the event of a malfunction. These are areas called “fire compartments”. Conversely, other areas called “non-fire compartments” are devoid of the risk of direct ignition. However, they must be protected from a fire originating in a fire compartment. For example, the inside of a nacelle constitutes a fire compartment and the outside of the nacelle is a non-fire compartment.

Thus, It is necessary to attach heat shields inside the nacelle making it possible to prevent or delay the spread of fire from the interior to the exterior of the nacelle in the event of a malfunction.

One example of a known attachment system is described in the document FR 2 829 811. Such an attachment system uses a lockwire system and a retaining button. The retaining button bears against an outer surface of the heat shield so as to form a holding and tightening washer, the retaining button being provided with holes for passing through the lockwire the ends of which are twisted and tightened. However, using such an attachment system becomes difficult, or even impossible, in confined spaces, particularly when the width of the heat shield to be attached is less than 30 mm.

Generally, the known attachment systems do not make easy installation in deep and/or narrow spaces possible.

### Disclosure of the Invention

The aim of the invention is therefore to facilitate the assembly of heat shields on aircraft panels.

The object of the invention is a device for attaching a heat shield to an aircraft panel, comprising a first attachment element associated with the heat shield, a second attachment element associated with the aircraft panel and a wire forming a loop.

At least one of said first and second attachment elements is provided with means for retaining said loop, said loop being closed by a braking member at the ends of said loop intended for bringing said attachment elements together, said loop abutting respectively in the middle portion thereof on one of said attachment elements and at the braking member on the other of said attachment elements.

Preferably, the first attachment element is attached to the heat shield.

Preferably, the second attachment element is attached to the aircraft panel.

Advantageously, the loop is set apart from the heat shield and from the aircraft panel, the loop passing outside the heat shield and the aircraft panel. Thus, the metal wire does not pass through the heat shield or the aircraft panel.

Advantageously, the metal wire is away from a contact area between said aircraft panel and said heat shield.

According to an advantageous feature, said retention means are designed to prevent any out-of-plane movement of said loop. Preferably, the out-of-plane movement of the loop is prevented by the retention means when the loop is braked in the tightened position.

For example, said device comprises a third attachment element comprising a central portion pierced with two holes and connecting first and second lateral portions that are parallel and substantially perpendicular to the central portion, said first and second lateral portions being respectively disposed between the heat shield and the first attachment element, and between the aircraft panel and the second attachment element, said two holes being passed through by said loop, and said central portion being disposed between the twist of said loop and the attachment element whereon said twist abuts.

For example, said third attachment element further comprises a third and fourth lateral portion that are parallel and substantially perpendicular to the central portion, extending in the extension of the first and second lateral portions on the opposite side of said central portion.

According to another aspect, the object of the invention is a method for attaching a heat shield to an aircraft panel using an attachment device as described above.

The method comprises successive steps of:
positioning said heat shield and said panel;
engaging a loop of metal wire in said means for retaining said attachment elements; and,
closing said loop by performing a twist of the ends of said loop intended for bringing said attachment elements together and tighten said attachment elements.

Preferably, the attachment method further comprises an additional step of folding said twist, performed after the closing step.

According to an advantageous feature, the method comprises an additional step of installing a third attachment element comprising a central portion pierced with two holes, connecting first and second lateral portions that are parallel and substantially perpendicular to the central portion, said central portion being threaded into the loop through the holes, said first and second lateral portions being installed respectively between the heat shield and the first attachment element, and between the aircraft panel and the second attachment element, said installation step being performed after the engagement step.

According to another aspect, the object of the invention is a turbine engine nacelle provided with an attachment device as defined above.

### BRIEF DESCRIPTION OF THE DRAWINGS

Other aims, features and advantages of the invention will become apparent upon reading the following description, given only by way of non-limiting example, and made with reference to the appended drawings wherein:

FIG. 1 and FIG. 2 are sectional views of an attachment device according to the invention;

FIG. 3 is a perspective view of the attachment device of FIG. 1, without the metal wire;

FIG. 3 is a perspective view of the attachment device of FIG. 2; and

FIG. 5 and FIG. 6 illustrate a second embodiment according to the invention;

FIG. 7 is a sectional view of a variant of the embodiment of FIGS. 5 and 6;

FIG. 8 is a flowchart of an attachment method according to the invention; and

FIG. 9 is a schematic sectional view of a turbine engine nacelle provided with an attachment device according to the invention.

### DETAILED DISCLOSURE OF AT LEAST ONE EMBODIMENT

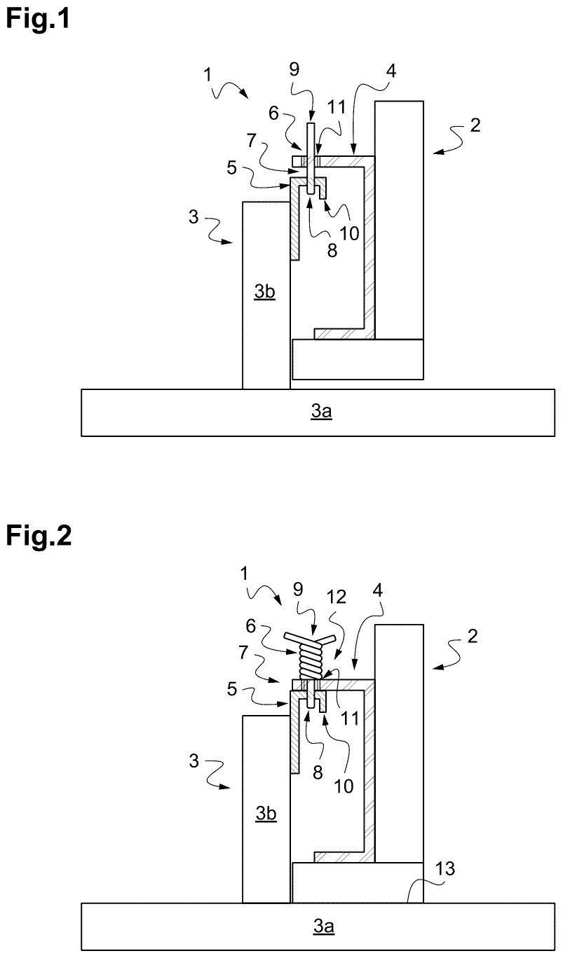

FIGS. 1 and 2 are sectional views of an attachment device 1 for attaching a heat shield 2 to an aircraft panel 3, as described according to one embodiment of the invention. The aircraft panel 3 comprises an axial part 3a and a radial part 3b. The attachment device 1 is illustrated in the untightened position in FIG. 1 and in the tightened position in FIG. 2.

The attachment device 1 comprises a first attachment element 4 attached to the heat shield 2, a second attachment element 5 attached to the aircraft panel 3 and a wire 6 forming a loop 7 that passes into the retention means 10, 11 provided on at least one of the attachment elements 4, 5. The loop 7 has a middle portion 8 and two ends 9. The retention means 10 and 11 of the loop 7 are configured to prevent an out-of-plane movement of the loop 7. In the illustrated embodiment, the attachment elements 4 and 5 are both provided with means for retaining 10 and 11 the loop 7. Alternatively, only one of the attachment elements 4 or 5 is provided with such retention means.

The wire 6 may in particular be metal.

The attachment elements 4 and 5 may in particular be plates, angle brackets, or hooks.

The retention means 10, 11 may in particular be hooks, grooves, notches, holes, or slots. The retention means 11 provided on the attachment element 4 may be different from the retention means 10 provided on the attachment element 5.

The loop 7 is closed by a braking member 12. The braking member 12 is in particular a twist of the ends 9 of the wire 6.

When the loop 7 is closed by a twist 12 of the ends 9, the attachment elements 4 and 5 are brought together, and the loop 7 abuts respectively in the middle portion 8 thereof on the second attachment element 5 and at the twist 12 on the first attachment element 4 (FIG. 2). The twist 12 is performed so that the heat shield 2 is in contact with the axial part 3a of the aircraft panel 3 on a contact area 13.

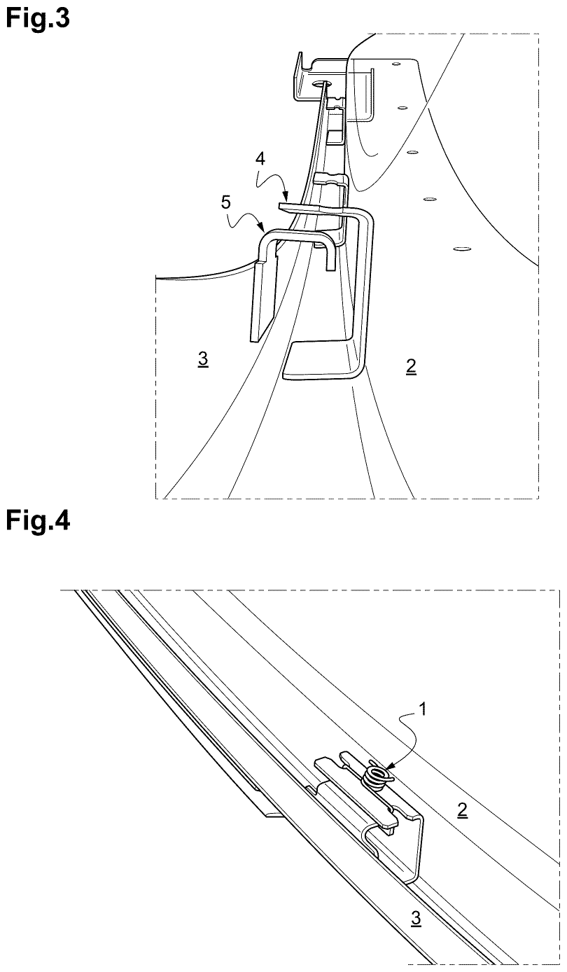

FIG. 3 is a perspective view of the first 4 and second 5 attachment elements without the metal wire 6.

FIG. 4 is a perspective view of the attachment device 1 in the tightened position. It should be noted that thanks to the attachment device 1, the metal wire 6 is away from the contact area 13 (FIG. 2). In other words, the attachment elements 4 and 5 extend from the panel 3 and the heat shield 2 in the direction opposite to the contact area 13, creating an interaction area between the wire 6 and the elements 4 and 5 which is set apart from the contact area 13.

The installation of such an attachment is thus facilitated, because benefiting from improved accessibility.

Furthermore, thanks to the attachment device 1, the loop 7 is set apart from the heat shield and from the aircraft panel, without the metal wire 6 passing through either said heat shield or said aircraft panel. Thus, the ease of assembly and the effectiveness of the heat shields are improved because there is no need to provide recesses or drill holes in the parts being attached, while also preventing thermal bridges.

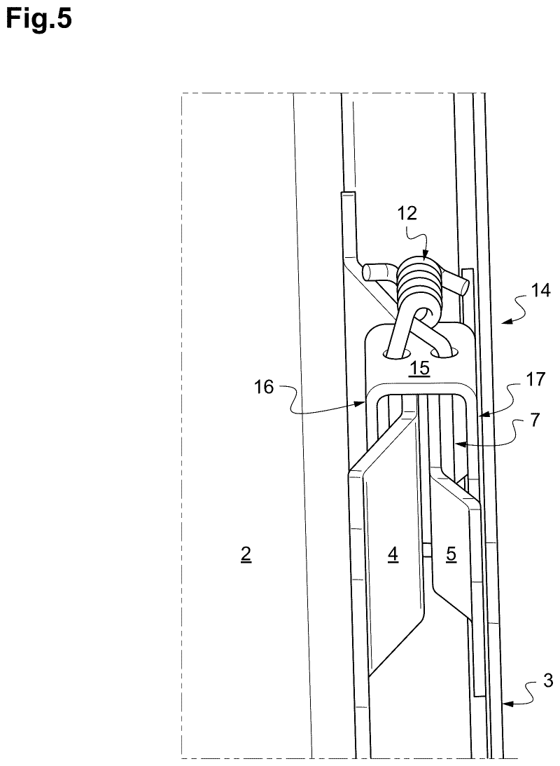

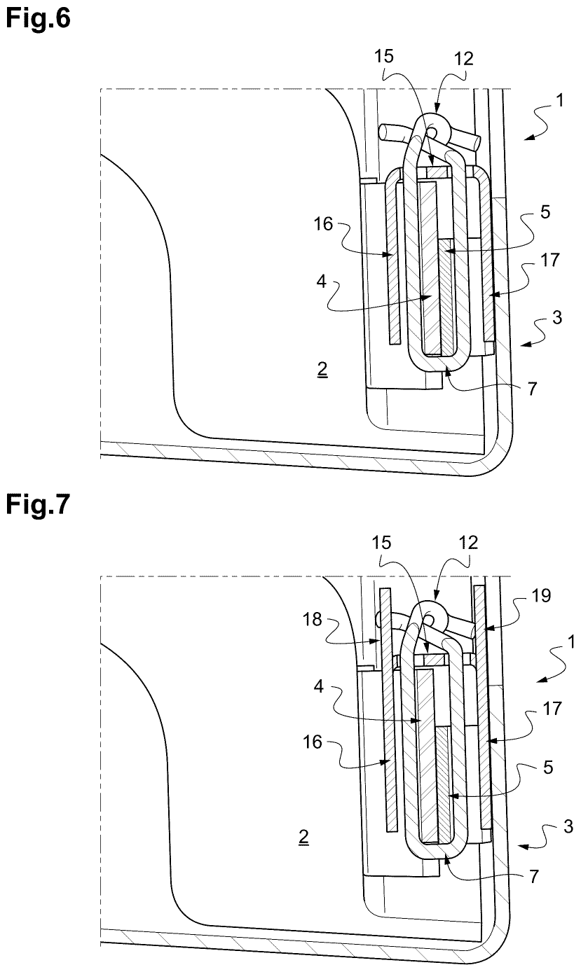

FIGS. 5 and 6 illustrate a second embodiment according to the invention.

In this embodiment, the attachment device 1 comprises a first attachment element 4 attached to the heat shield 2, a second attachment element 5 attached to the aircraft panel 3, and a metal wire 6 forming a closed loop 7 closed by a twist 12.

The attachment device 1 further comprises a third attachment element 14 comprising a central portion 15 pierced with two holes, connecting the first 16 and second 17 lateral portions that are parallel and substantially perpendicular to the central portion 15. In the illustrated example, the first 16 and second 17 lateral portions have the same length. Alternatively, the first 16 and second 17 lateral portions may have different lengths.

The first 16 and 17 lateral portions are disposed respectively between the heat shield 2 and the first attachment element 4, and between the aircraft panel 3 and the second attachment element 5.

The two holes are passed through by the loop 7, and the central portion 15 is disposed between the twist 12 of the loop 7 and the attachment element 4 whereon the twist 12 abuts.

Such an attachment device 1 provided with the third attachment element 14 makes it possible to reduce the risk of breakage of the metal wire 6 when closing the loop by twisting the ends. Indeed, in the absence of the third attachment element 14, the loop abuts either at the twist on the first attachment element 4 or the second attachment element 5. In this area, the metal wire 6 undergoes stresses due to the crushing generated by the abutment of the twist 12 in addition to the high tangential torsional stresses. Given that the crushing stresses are inversely proportional to the size of the abutment, there is a significant risk of breakage of the wire 6 when the twist abuts a relatively small area, such as the thickness of an attachment element 4 or 5. Using the third attachment element 15 makes it possible to increase the size of the abutment so as to reduce the risk of breakage of the wire 6.

FIG. 7 is a sectional view of a variant of the second embodiment according to the invention.

In this variant, the third attachment element 14 further comprises third 18 and fourth 19 lateral portions that are parallel and substantially perpendicular to the central portion 15 and extending in the extension of the first 16 and second 17 lateral portions on an opposite side of the central portion 15.

The third and fourth lateral portions make it possible to protect the heat shield and the aircraft panel from possible damage caused by the twist 12. Indeed, when folding the twist 12, it is possible that the twist 12 is inadvertently tilted toward the heat shield or toward the aircraft panel with a risk of damaging the latter. The use of a third attachment element 15 with the third 18 and fourth 19 lateral portions introduces a physical protective barrier between the twist 12 and the parts to be protected so as to reduce the risk of damage.

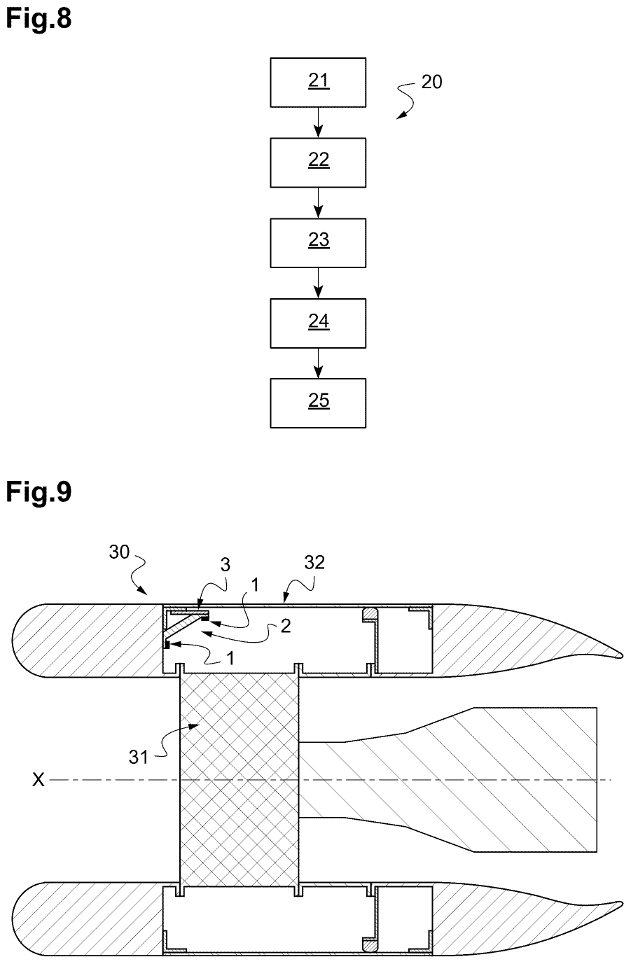

FIG. 8 is a flowchart of a method 20 for attaching a heat shield to an aircraft panel according to the invention.

The method begins with a step 21 of positioning the heat shield 2 and the aircraft panel 3.

The method continues with a step 22 of engaging a loop 7 of metal wire 6 in retention means 10, 11 provided on at least one of the first and second attachment elements 4, 5.

During the next step 24, the loop is closed and a twist of the ends of the loop is performed intended for bringing together and tighten the attachment elements.

During the next step 25, the twist is folded in order to reduce the size thereof.

The method comprises an optional step 23 of installing a third attachment element 14 as previously described, step 23 being performed after the engagement step 22 and before the closing step 24. During step 23, the central portion 15 of the third attachment element 14 is threaded into the loop 7 through the holes until it comes into contact with an attachment element, the first 16 and second 17 lateral portions being installed respectively between the heat shield 2 and the first attachment element 4, and between the aircraft panel 3 and the second attachment element 5. It is understood that the twist 12 of the loop 7 is performed in the case of installing the third attachment element 14 only after passing the loop 7 of metal wire 6 through the holes of the central portion 15.

The attachment device 1 described above is advantageously intended to equip a turbine engine nacelle 30 or aircraft engine that can be seen in FIG. 9.

FIG. 9 shows very schematically an axial section of a turbine engine 31, with a longitudinal general axis X, for example of the twin spool turbofan engine type.

The access to the motor 31 is provided by a movable cover 32.

Numerous heat shields 2 are attached using devices 1 on panels 3 of the nacelle 30 to prevent or delay the passage of flames from the motor 31 to the exterior of the nacelle 30, and to thermally insulate certain parts that could reignite gases outside the nacelle 30.

It should be noted that the attachment device 1 of the invention may equip any type of nacelle and attach any type of heat shield.

1. Device for attaching a heat shield to an aircraft panel, comprising a first attachment element associated with the heat shield, a second attachment element associated with the aircraft panel and a wire forming a loop, wherein at least one of said first and second attachment elements is provided with retention means for retaining said loop, said loop being closed by a braking member of the ends of said loop for bringing said attachment elements together, said loop abutting respectively in a middle portion thereof on one of said attachment elements and at the level of the braking member on the other of said attachment elements, said loop being set apart from said heat shield and said aircraft panel, said loop passing outside said heat shield and said aircraft panel, said attachment elements extending from said aircraft panel and said heat shield in a direction opposite to a contact area between said aircraft panel and said heat shield.

2. Device according to claim 1, wherein said wire is away from the contact area between said aircraft panel and said heat shield.

3. Device according to claim 1, wherein said retention means are configured to prevent an out-of-plane movement of said loop.

4. Device according to claim 1, wherein said device comprises a third attachment element comprising a central portion pierced with two holes and connecting first and second lateral portions that are parallel and substantially perpendicular to the central portion, said first and second lateral portions being disposed respectively between the heat shield and the first attachment element, and between the aircraft panel and the second attachment element, said two holes being passed through by said loop and said central portion being disposed between the twist of said loop and the attachment element whereon said twist abuts.

5. Device according to claim 4, wherein said third attachment element further comprises a third and fourth lateral portion that are parallel and substantially perpendicular to the central portion, extending in the extension of the first and second lateral portions on the opposite side of said central portion.

6. Method for attaching a heat shield to an aircraft panel using an attachment device according to claim 1, the method comprising successive steps of:
positioning said heat shield and said panel;
engaging a loop of metal wire in said means for retaining said attachment elements; and
closing said loop by performing a twist of the ends of said loop intended for bringing said attachment elements together.

7. Attachment method according to claim 6, further comprising an additional step of folding said twist performed after the closing step.

8. Attachment method according to claim 6, comprising an additional step of installing a third attachment element comprising a central portion pierced with two holes, connecting first and second lateral portions that are parallel and substantially perpendicular to the central portion, said central portion being threaded into the loop through the holes, and the first and second lateral portions being installed respectively between the heat shield and the first attachment element, and between the aircraft panel and the second attachment element, said installation step being performed after the engagement step.

9. Turbine engine nacelle provided with at least one attachment device according to claim 1.
